(19) United States
(12) Patent Application Publication
(10) Pub. No.: US 2016/0310980 A1
(43) Pub. Date: Oct. 27, 2016

(54) Coating Machine and Controlling Method Thereof

(71) Applicants: BOE Technology Group Co., Ltd., Beijing (CN); Hefei BOE Optoelectronics Technology Co., Ltd., Anhui (CN)

(72) Inventors: Zhiqiang Li, Beijing (CN); Dongdong Yin, Beijing (CN); Xuepei Cheng, Beijing (CN); Qinghua Gong, Beijing (CN); Ling Wu, Beijing (CN)

(21) Appl. No.: 15/083,519

(22) Filed: Mar. 29, 2016

(30) Foreign Application Priority Data
Apr. 27, 2015 (CN) 201510205222.1

(51) Int. Cl. B05B 12/12; B05B 13/02

(52) U.S. Cl. CPC B05B 12/12; B05B 13/02

(57) ABSTRACT

A coating machine and a controlling method thereof are disclosed. The coating machine includes: a coating platform, configured to support a substrate to be placed thereon; a supporting device, configured to support the coating platform and adjust height; a detecting device, configured to detect a levelness of a supporting plane formed by the supporting device; a driving device, configured to drive the supporting device to adjust the supporting plane; a control device, configured to compare the levelness of the supporting plane detected by the detecting devices with a preset threshold range of levelness. If the detected levelness of the supporting plane is beyond the preset threshold range of levelness, the control device adjusts the supporting devices until the levelness of the supporting plane is within the preset threshold range of levelness.

This application claims priority to and the benefit of Chinese Patent Application No. 201510205222.1 filed on Apr. 27, 2015, which application is incorporated herein in its entirety.

### TECHNICAL FIELD

Embodiments of the present disclosure relate to a coating machine and controlling method thereof.

### BACKGROUND

A coating machine is a process equipment configured to coat photoresist onto a glass substrate evenly. A coating platform is used for placing the glass substrate thereon. If a supporting point of the coating platform varies in height, the coating platform will be inclined, and a levelness of the coating platform will be deteriorated, which may lead the coating gap of the coating machine to be inconsistent during the process of coating and therefore cause uniformity of coating to be deteriorated.

### SUMMARY

An embodiment of the disclosure provides a coating machine, and the coating machine comprises: a coating platform, configured for a substrate to be placed on; a supporting device, configured to support the coating platform and adjust height; a detecting device, configured to detect a levelness of a supporting plane formed by the supporting device; a driving device, configured to drive the supporting device to adjust the supporting plane; a control device, configured to compare the levelness of the supporting plane detected by the detecting devices with a preset threshold range of levelness, if the detected levelness of the supporting plane is beyond the preset threshold range of levelness, the control device adjusts the supporting devices until the levelness of the supporting plane is within the preset threshold range of levelness.

Another embodiment of the disclosure provides a controlling method for the above coating machine, the controlling method comprising: detecting a levelness of the supporting plane of the supporting device by the detecting device; and controlling the driving device to adjust the supporting plane of the supporting device to be within a preset threshold range of levelness if the supporting plane of the supporting devices is beyond the preset threshold range of levelness.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a top view of a coating machine provided by an embodiment of the disclosure;

FIG. 2 is a structural schematic diagram of a height adjusting device of the coating machine provided by the embodiment of the disclosure; and

FIG. 3 is a front view of the coating machine provided by the embodiment of the disclosure.

### REFERENCE NUMBERS

1—coating platform; 2—roller; 3—nozzle; 4—height adjusting device; 5—driving motor; 6—grating ruler; 7—coupling; 8—screw rod; 9—wedge; 10—strutting piece; 11—base

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

In a coating machine, height variations of a supporting point or supporting points of the coating platform thereof cannot be monitored, and the levelness of the coating platform is difficult to be adjusted as well. Because the levelness of the platform cannot be monitored in realtime, it cannot be found on time if the coating platform is inclined. Also, no quantified standard can be used when the coating platform is adjusted, and the coating platform has to be adjusted manually based on feelings and experience of an operator. Therefore, it is difficult to adjust and hard to guarantee the levelness after adjusting.

In order to improve coating effects of a coating machine, an embodiment of the disclosure provides a coating machine and a controlling method thereof. In the technical solution of the embodiment of the disclosure, a levelness of a coating platform is adjusted by a height adjusting device, so that inclination of the coating platform during coating can be prevented, improving coating effects effectively.

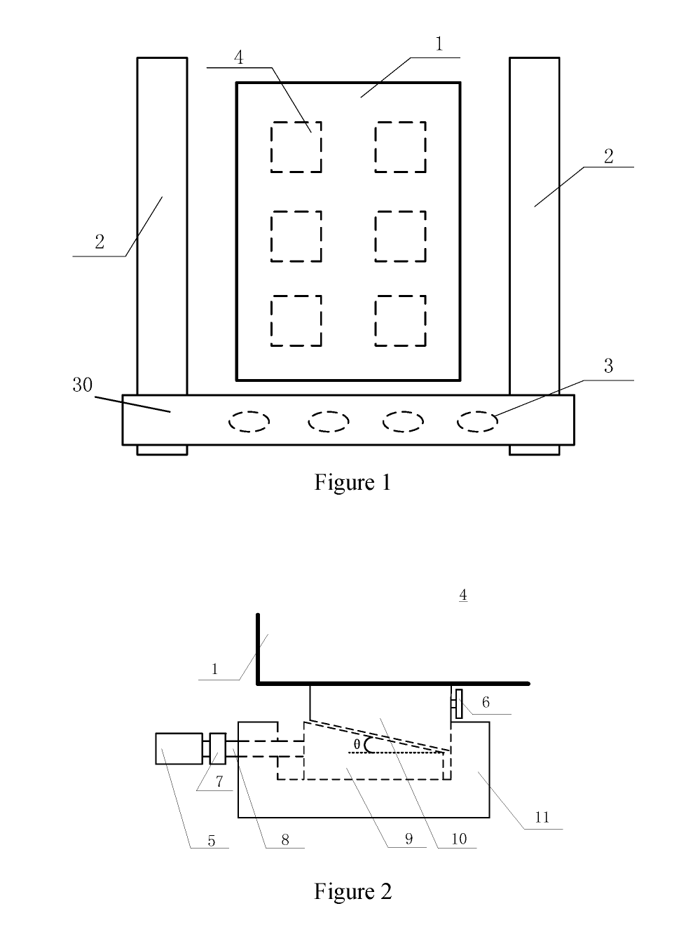

Embodiments of the disclosure will be described with reference to FIGS. 1, 2 and 3. FIG. 1 illustrates a top view of a coating machine provided by an embodiment of the disclosure, and FIG. 2 illustrates a structural schematic diagram of a height adjusting device of the coating machine provided by the embodiment of the disclosure.

As shown in the figures, the embodiment of the disclosure provides a coating machine. The coating machine includes: a coating platform 1, configured for a substrate to be placed thereon; a supporting device, configured to support the coating platform 1 and adjust height of the coating platform 1; a detecting device, configured to detect a levelness of a supporting plane formed by the supporting device; a driving device, configured to drive the supporting device to adjust the supporting plane; a control device, configured to compare the levelness of the supporting plane detected by the detecting device with a preset threshold range of levelness. If the detected levelness of the supporting plane is beyond the preset threshold range of levelness, the control device adjusts the supporting devices until the levelness of the supporting plane is within the preset threshold range of levelness.

In the above embodiment, the coating platform is supported by the supporting device, and the levelness of the supporting plane provided by the supporting device is detected by the detecting device. Meanwhile, the levelness of the supporting plane formed by the supporting device can be adjusted by the control device based on the detecting result of the detecting device, so that the levelness of the plane of the supporting substrate of the coating platform can be guaranteed during the process of coating photoresist for example, the coating platform can prevent from being inclined during coating, which improves coating effects.

In order to facilitate understanding to the coating machine provided by the embodiment of the disclosure, structures and working principles of the coating machine will be described in details in conjunction with FIGS. 1, 2 and 3.

As shown in FIG. 1, the coating machine provided by an embodiment of the disclosure includes a coating platform 1, the coating platform 1 is supported by a plurality of supporting devices, travelling rollers 2 are disposed systematically on both sides of the coating platform 1, a beam is assembled on the systematically disposed travelling rollers 2, so that the beam can travel by means of the travelling rollers. A nozzle or nozzles 3 are disposed on the beam. When the beam is sliding, the nozzles 3 spray or coat photoresist for example onto the substrate placed on the coating platform so as to perform coating process.

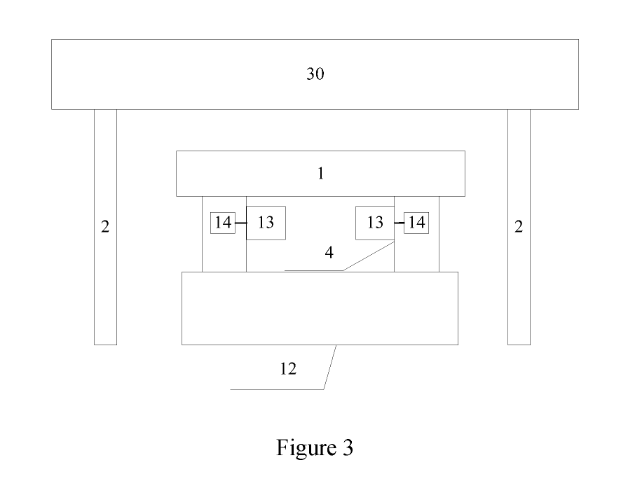

As shown in FIG. 3, the coating machine provided by an embodiment of the disclosure includes: a coating platform 1, configured for supporting a substrate to be placed thereon; at least one supporting device 12, configured to support the coating platform 1 and adjust the height of the coating platform; a detecting device 13, configured to detect a levelness of a supporting plane provided by the supporting device 12; a driving device, configured to drive the supporting device 12 to adjust the supporting plane; a control device 14, configured to control the driving device to drive the supporting device 12 until the levelness of the supporting plane is within a preset threshold range of levelness if the detected levelness of the supporting plane is beyond the preset threshold range of levelness. The coating machine of the embodiment provides a supporting structure, which will be described in the followings in conjunction with FIG. 2. Other structures of the coating machine may be implemented in a conventional configuration, the description of which will be omitted herein.

FIG. 2 illustrates a structural schematic diagram of a height adjusting device 4 for supporting the coating machine 1. With reference to FIGS. 1 and 2, the supporting device 12 may include at least two height adjusting devices 4. A detecting device 13 is disposed to correspond to each of the height adjusting devices 4 and configured to detect a supporting height of the corresponding height adjusting device 4, and therefore detecting devices may be provided. A driving device is disposed corresponding to each of the height adjusting devices 4 and drives the corresponding height adjusting devices 4 to adjust the supporting height, and therefore driving devices may be provided.

A plurality of height adjusting devices 4 may be provided. For example, four or six height adjusting devices 4 may be provided to achieve a better supporting effect, as well as preventing a high cost of the whole apparatus due to too many height adjusting devices 4. It should be noted that the number of the height adjusting devices 4 is not limited to the examples in the above-described specific embodiment, and may vary according to the size of the coating platform 1 specifically.

In an example, each of the height adjusting devices 4 includes: a base 11, in which a notch is provided; a strutting piece 10 that is sliding assembled on a side wall of the notch and capable of sliding along a vertical direction; a wedge 9 configured for driving the strutting piece 10 to slide along the vertical direction. In this embodiment, the detecting device is a grating ruler 6, which is disposed on the strutting piece 10; the driving device may include a driving motor 5 and a screw rod 8 connected to the driving motor 5, and the screw rod 8 is connected to the wedge 9 through threads.

Specifically, the height adjusting device 4 includes a base 11, a strutting piece 10 sliding along a vertical direction, and a wedge 9 sliding along a horizontal direction. The strutting piece 10 partially stacks on the wedge 9. When the wedge 9 moves horizontally, it drives the strutting piece 10 to move vertically. For the convenience of description, the direction where the wedge 9 is placed is used as a reference direction. When the wedge 9 is moved to right, the wedge 9 pushes the strutting piece 10 upward. When the wedge 9 is moved to left, the strutting piece 10 slips downward under the gravity force of both the strutting piece 10 itself and the coating platform, so that the height of the platform can be adjusted. As shown in FIG. 2, during installation, a notch is provided on the base 11, the strutting piece 10 is sliding assembled at a side wall of the notch, and the wedge 9 is sliding assembled on the bottom of the notch. Sliding notches may be provided at the side wall of the notch and the bottom of the notch respectively, so that the strutting piece 10 and the wedge 9 are sliding installed correspondingly. Besides, in order to guarantee a horizontal movement of the wedge 9 to be converted into a vertical movement of the strutting piece 10, a slope surface of the wedge 9 is stacked on the bottom of the strutting piece 10, for example. When the wedge 9 is moved, the slope of the wedge 9 pushes the strutting piece 10 to move upward vertically. The inclination angle of the slope surface of the wedge 9 may be set according to requirements. Optionally, an angle between the slope surface of the wedge 9 and the horizontal plane is in a range of 10°-60°. For example, the inclination may be any degree within the range of 10°-60°, such as 10°, 15°, 20°, 30°, 40°, 50°, 60° and the like. As shown in FIG. 2, θ is the angle between the slope surface and the horizontal plane.

Besides, in order to reduce stress between the strutting piece 10 and the wedge 9, the strutting piece 10 has a slope surface which fits or matches the slope surface of the wedge 9. That is, the bottom of the strutting piece 10 has a structure of inclination surface, and inclination angle of the structure corresponds to the inclination angle of the wedge 9, as shown in FIG. 2. In this way, the contact area between the wedge 9 and the strutting piece 10 is increased, therefore improving supporting ability effectively.

It should be understood that, the height adjusting device 4 in the embodiments of the disclosure is not limited to the structure mentioned in above specific embodiment. It may include any other supporting structures capable of adjusting the height freely, such as a cylinder, a hydraulic cylinder, a cam or the like supporting and adjusting structures.

As for the driving device and the detecting device, description will be performed by taking the height adjusting device 4 with a structure including the wedge 9 and the strutting piece 10 as an example.

The driving device includes a driving motor 5 and a screw rod 8 connected to the driving motor 5, and the screw rod 8 is connected with the wedge 9 by means of threads. That is, the driving device includes one driving motor 5, the driving motor 5 is connected to the screw rod 8 by a coupling 7, the screw rod 8 is in threaded connection with the wedge 9. Upon the driving motor 5 rotating the screw rod 8, the screw rod 8 drives the wedge 9 to move on the base 11.

Herein, in an example, the detecting device is a grating ruler 6. For example, a scale grating of the grating ruler 6 is fixed on the coating platform 1, and the decoder of the grating ruler is fixed on the strutting piece 10. When the height of the strutting piece 10 changes, readings of the decoder of the grating ruler 6 changes accordingly. By fixing the grating ruler 6 on the base 11 of the roller 2, the case that readings of the decoder will not change when the coating platform 1 and heights of its supporting points change can be avoided.

Herein, the controlling device includes PLC, CPU, DSP, MCU or the like, which can provide good controlling effects.

In practice, after the installation and debug of the coating platform 1, the grating rulers 6 for each of the supporting points are reset to 0 for example. During subsequent usage, the grating rulers 6 feed information with regard to heights of the supporting points back to the controlling device (e.g., a PLC). If the reading of a certain grating ruler 6 changes, e.g., goes beyond the preset range, indicating that the platform become inclined, the PLC (the controlling device) receives data, calculates the amount for adjusting, and then performs adjusting on time by driving the motor. In order to restore the levelness of the platform, the advance distance of the motor during adjusting can be calculated with the height variations of the supporting points and the slope angle of the wedge 9. For example, when the grating ruler 6 has a reading of −10 μm, it shows that the height of the supporting point corresponding to the grating ruler 6 decreases by 10 μm. If the slope angle of the wedge 9 is 15°, the advance distance of the motor is 10/tanθ=37.3 μm. If the heights of the supporting points still fall without the preset range after the adjustment of the motor, the whole controlling system will continue to adjust the heights of the supporting points according to the above method until the heights of the supporting points still fall within an allowable range.

An embodiment of the disclosure further provides a controlling method for the coating machine. The controlling method includes steps of: detecting a levelness of a supporting plane provided by supporting devices by detecting devices; and controlling driving devices to adjust the supporting plane of the supporting devices to be within a preset threshold range of levelness, and if the supporting plane of the supporting devices is beyond the preset threshold range of levelness.

In above embodiments, the coating platform is supported by the supporting devices, and the levelness of the supporting plane formed by the supporting devices is detected by the detecting device. Meanwhile, the levelness of the supporting plane formed by the supporting devices is adjusted by the control device based on the detecting result of the detecting devices, so that the levelness of the plane of the supporting substrate of the coating platform is guaranteed during coating photoresist for example, preventing the coating platform from being inclined during coating, which therefore improves coating effects.

If the supporting plane of the supporting devices is beyond the preset threshold range of levelness, the driving device is controlled to adjust the supporting plane of the supporting devices to be within the preset threshold range of levelness. For example, the screw rod is driven by a driving motor, the screw rod pushes the wedge to move horizontally, and upon the wedge being moved, the wedge pushes the strutting piece to slide upward along a vertical direction. Heights of the height adjusting devices are detected by the grating ruler, the controlling device stops the driving motor when supporting heights of the height adjusting devices, which is detected by the grating ruler, are within a specified threshold of height.

For example, the embodiment guarantees a levelness of the coating platform by controlling the supporting heights of the height adjusting device through the controlling device. When the supporting height of the height adjusting device is beyond the specified threshold of height, the supporting height of the height adjusting device can be adjusted to be within the specified threshold of height again.

It should be understood that above-mentioned embodiments are merely exemplary embodiments of the disclosure for illustrating principles of the disclosure, and the disclosure is not limited to this. It is obviously for those skilled in this art that any change or variation can be made to the embodiments without a departure from the spirit and scope of the disclosure. As such, these changes or variations are intended to be included within the disclosure.

This application claims the priority of Chinese Patent Application No. 201510205222.1 filed on Apr. 27, 2015, which is hereby incorporated entirely herein by reference.

1. A coating machine, comprising:
a coating platform, configured to support a substrate to be placed thereon;
a supporting device, configured to support the coating platform and adjust height;
a detecting device, configured to detect a levelness of a supporting plane formed by the supporting devices;
a driving device, configured to drive the supporting device to adjust the supporting plane; and
a control device, configured to compare the levelness of the supporting plane detected by the detecting devices with a preset threshold range of levelness, where if the detected levelness of the supporting plane is beyond the preset threshold range of levelness, the control device adjusts the supporting device until the levelness of the supporting plane is within the preset threshold range of levelness.

2. The coating machine of claim 1, wherein the supporting device comprises at least two height adjusting devices.

3. The coating machine of claim 2, wherein the coating machine comprises at least two detecting devices for the at least two height adjusting devices.

4. The coating machine of claim 3, wherein the detecting devices are disposed to correspond to each of the height adjusting devices and configured to detect supporting heights of the corresponding height adjusting devices.

5. The coating machine of claim 2, wherein the coating machine comprises at least two detecting devices for the at least two driving devices.

6. The coating machine of claim 5, wherein the driving devices are disposed to correspond to each of the height adjusting devices and drive the corresponding height adjusting devices to adjust supporting heights.

7. The coating machine of claim 2, wherein each of the height adjusting devices comprises:
a base, in which a notch is disposed;
a strutting piece, that is configured for sliding assembled on a side wall of the notch and capable of sliding along a vertical direction; and
a wedge, configured for driving the strutting piece to slide along the vertical direction.

8. The coating machine of claim 7, wherein the detecting device comprises a grating ruler, a scale grating of the grating ruler is fixed on the coating platform, and a decoder of the grating ruler is fixed on the strutting piece.

9. The coating machine of claim 7, wherein the driving device includes a driving motor and a screw rod connected to the driving motor, and the screw rod is in threaded connection to the wedge.

10. The coating machine of claim 7, wherein, the wedge is sliding assembled on a bottom of the notch.

11. The coating machine of claim 10, wherein an angle between a slope surface of the wedge and a horizontal plane is in a range of 10°-60°.

12. The coating machine of claim 11, wherein the strutting piece has a slope surface which fits the slope of the wedge.

13. The coating machine of claim 2, wherein a number of the height adjusting device is four or six.

14. The coating machine of claim 1, wherein the controlling device is PLC, CPU, DSP, or MCU.

15. A controlling method for the coating machine of claim 1, comprising:
detecting a levelness of a supporting plane provided by the supporting device by the detecting device; and
controlling the driving device to adjust the supporting plane of the supporting device to be within a preset threshold range of levelness if the supporting plane of the supporting devices is beyond the preset threshold range of levelness.
